(19) United States
(12) Patent Application Publication
(10) Pub. No.: US 2025/0292047 A1
(43) Pub. Date: Sep. 18, 2025

(54) INFORMATION PROCESSING APPARATUS, INKJET PRINTING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Tatsuhiro Yamagata, Tokyo (JP); Okinori Tsuchiya, Kanagawa (JP); Takashi Fujita, Tokyo (JP); Hiromitsu Yamaguchi, Kanagawa (JP); Akitoshi Yamada, Kanagawa (JP); Hidetsugu Kagawa, Kanagawa (JP)

(21) Appl. No.: 19/075,902

(22) Filed: Mar. 11, 2025

(30) Foreign Application Priority Data
Mar. 15, 2024 (JP) 2024-041586

(51) Int. Cl. G06K 15/16; B41J 3/44; B41J 11/00; B41J 13/10; G06K 15/00; G06K 15/10

(52) U.S. Cl. CPC G06K 15/16; B41J 3/44; B41J 11/0005; B41J 11/006; B41J 13/106; G06K 15/102; G06K 15/403; G06K 15/4085

(57) ABSTRACT

An information processing apparatus controlling an inkjet printing apparatus in which a post-processing mechanism that can execute a plurality of post-processing processes on the medium can be installed at a discharge unit, the information processing apparatus comprises a storage unit storing print settings that include at least a first print setting and a second print setting different from the first print setting; and a control unit setting the first print setting for executing a first post-processing process and setting the second print setting for executing a second post-processing process different from the first post-processing process, wherein the control unit sets the first print setting so that paper is discharged with a reduced curl amount more than in a case where the post-processing process is not executed, and sets the second print setting so that paper is discharged with a curl amount reduced more than the first print setting.

### BACKGROUND

### Technical Field

The present disclosure relates to an information processing apparatus, an inkjet printing apparatus, an information processing method, and a non-transitory computer-readable storage medium.

### Description of the Related Art

When using a printing apparatus such as a printer, a post-processing process performed after printing such as stapling may take time. To solve this problem, a mechanism installed with a post-processing process function may be independently disposed and post-processing may be automatically performed to improve productivity (Japanese Patent Laid-Open No. 2022-70446). However, the installation space is increased by making the post-processing process independent. Regarding this, a printing apparatus is proposed for realizing a post-processing process without increasing space by inserting a small post-processing mechanism at a discharge unit that discharges a printing medium.

### SUMMARY

According to one aspect of the present disclosure, there is provided an information processing apparatus that controls an inkjet printing apparatus that prints an image on a printing medium and in which a post-processing mechanism that can execute a plurality of types of post-processing processes on the printing medium printed with the image can be installed at a discharge unit that discharges the printing medium, the information processing apparatus comprising: a storage unit that stores print settings for printing the image that include at least a first print setting and a second print setting different from the first print setting; and a control unit that sets the first print setting for executing a first post-processing process from among the post-processing processes and sets the second print setting for executing a second post-processing process different from the first post-processing process from among the post-processing processes, wherein the control unit sets the first print setting so that paper is discharged with a reduced curl amount more than in a case where the post-processing process is not executed, and sets the second print setting so that paper is discharged with a curl amount reduced more than the first print setting.

According to another aspect of the present disclosure, there is provided an inkjet printing apparatus, comprising: the above-mentioned information processing apparatus according to claim 1; and a discharge unit that discharges the printing medium with the image printed and is installed with a post-processing mechanism that performs a post-processing process on the printing medium.

According to another aspect of the present disclosure, there is provided an information processing method for controlling an inkjet printing apparatus that prints an image on a printing medium and in which a post-processing mechanism that can execute a plurality of types of post-processing processes on the printing medium printed with the image can be installed at a discharge unit that discharges the printing medium, the method comprising: storing print settings for printing the image that include at least a first print setting and a second print setting different from the first print setting; and controlling to set the first print setting for executing a first post-processing process from among the post-processing processes and set the second print setting for executing a second post-processing process different from the first post-processing process from among the post-processing processes, wherein in the controlling the first print setting is set so that paper is discharged with a reduced curl amount more than in a case where the post-processing process is not executed, and the second print setting is set so that paper is discharged with a curl amount reduced more than the first print setting.

According to another aspect of the present disclosure, there is provided a non-transitory computer-readable storage medium storing a computer program for causing, when loaded and executed by a computer that controls an inkjet printing apparatus that prints an image on a printing medium and in which a post-processing mechanism that can execute a plurality of types of post-processing processes on the printing medium printed with the image can be installed at a discharge unit that discharges the printing medium, the computer to: store print settings for printing the image that include at least a first print setting and a second print setting different from the first print setting; and set the first print setting for executing a first post-processing process from among the post-processing processes and set the second print setting for executing a second post-processing process different from the first post-processing process from among the post-processing processes, wherein in the setting of the print setting the first print setting is set so that paper is discharged with a reduced curl amount more than in a case where the post-processing process is not executed, and the second print setting is set so that paper is discharged with a curl amount reduced more than the first print setting.

Further features of the present disclosure will become apparent from the following description of exemplary embodiments (with reference to the attached drawings).

### BRIEF DESCRIPTION OF THE DRAWINGS

FIG. 1 is a block diagram illustrating the overall configuration of a control system of a printing system.

FIG. 2 is a block diagram illustrating the flow of image data conversion processing.

FIG. 3 is a diagram illustrating in detail the overall configuration of a printing apparatus.

FIG. 4A illustrates a print setting UI operated by a user to set a print setting of the printing apparatus.

FIG. 4B illustrates a post-processing process selection UI for setting the post-processing process.

FIG. 5A illustrates a printing medium before printing.

FIG. 5B illustrates the printing medium after single-sided printing in a curled state.

FIG. 6A is a diagram illustrating the state of the printing medium discharged into a discharge tray.

FIG. 6B is diagram schematically illustrating the state of a preceding printing medium placed in the discharge tray being curled up and, in this state, a subsequent printing medium is discharged.

FIG. 7 is a diagram of the area near the discharge unit installed with a post-processing mechanism.

FIG. 8A is a diagram illustrating the direction that the sheet tends to curl.

FIG. 8B is a diagram illustrating the result of examining the relationship between the ejection amount of ink and the initial curling (curl) amount using the following method.

FIG. 9A is a diagram illustrating the relationship between printing time and curl amount.

FIG. 9B is a diagram illustrating the relationship between printing time and curl amount.

FIG. 10 is a diagram of a flowchart illustrating printing processing according to a first embodiment.

FIG. 11 is a diagram of a printing operation table.

FIG. 12A is a diagram for describing curling when there is no difference in the ink amount between the front and back sides.

FIG. 12B is a diagram for describing curling when there is a difference in the ink amount between the front and back sides.

FIG. 12C is a diagram illustrating the relationship between the difference in the ink amount between the front and back sides and the curl amount.

FIG. 13 is a diagram illustrating a UI for setting a post-processing process according to a second embodiment.

FIG. 14 is a diagram of a flowchart illustrating printing operations according to a third embodiment.

FIG. 15 is a diagram of a printing operation table for action against paper jam according to the third embodiment.

FIG. 16 is a diagram illustrating a paper jam occurrence information table.

FIG. 17 is a diagram of a flowchart illustrating printing processing according to a fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

When a post-processing mechanism is installed in a discharge unit, the height of the discharge port decreases, which tends to make the paper jam more often.

Regarding this, the present embodiment provides technology that can reduce paper jam even when a post-processing mechanism is installed in a discharge unit.

### First Embodiment

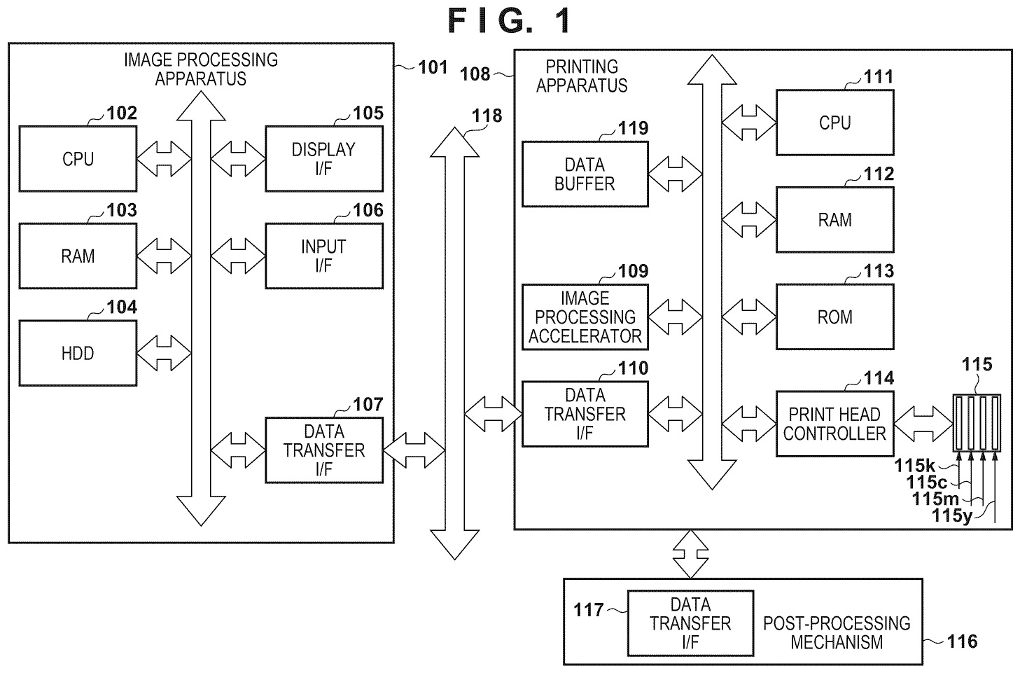

FIG. 1 is a block diagram for describing the overall configuration of a control system of a printing system according to the present embodiment. As illustrated in FIG. 1, the printing system includes an image processing apparatus 101, a printing apparatus 108, and a post-processing mechanism 116. The image processing apparatus 101 and the printing apparatus 108 are connected via a network 118 in a manner enabling information to be transmitted and received.

The image processing apparatus 101, on the basis of an instruction from a user or the like, generates data of an image for printing by the printing apparatus 108 and transmits the data to the printing apparatus 108. The image processing apparatus 101 is a computer such as a host personal computer (PC), a tablet PC, or the like. The image processing apparatus 101 includes a CPU 102, a RAM 103, an HDD 104, a display I/F 105, and input I/F 106, and a data transfer I/F 107.

The CPU 102 is an abbreviation of central processing unit and is processor such as a central processing unit. The image processing apparatus 101 may include, in addition to or instead of the CPU 102, a micro processing unit (MPU), a graphics processing unit (GPU), a quantum processing unit (QPU), or a similar processor. The CPU 102 reads out a program stored in the HDD 104, loads the program on the RAM 103 functioning as a working area, and executes various types of processing. Also, the CPU 102 executes various types of processing in accordance with commands received from the user via the input I/F 106 and a touch panel (not illustrated). For example, the CPU 102, in accordance with a command, executes a program stored in the HDD 104, generates image data printable by the printing apparatus 108, and transfers the image data to the printing apparatus 108. A part or all of the various types of processing executed by the CPU 102 may be implemented using one or more circuits such as an application specific integrated circuit (ASIC), a field programmable gate array (FPGA), or the like.

The RAM 103 is an abbreviation of random access memory and is a memory with high read and write speeds for data. The RAM 103 temporarily stores programs read out by the CPU 102 and temporarily stores data required to execute programs, data corresponding to program processing results, and the like.

The HDD 104 is an abbreviation of hard disk drive and is a non-volatile storage apparatus that can stored data without power being supplied. The HDD 104 stores programs, data required to execute programs, data corresponding to program processing results, and the like.

The display I/F 105 is an interface that connects to a display apparatus that displays images such as a liquid crystal display device, an organic electro luminescence (EL) display apparatus, or the like. The display I/F 105 outputs the image output by the CPU 102 to the display apparatus.

The input I/F 106 is an interface that connects to an input apparatus such as a keyboard, mouse, or the like for a user to input commands, data, and the like.

The data transfer I/F 107 is an interface that connects to the network 118. The data transfer I/F 107 outputs data output by the CPU 102 and the like to the printing apparatus 108, which is an external apparatus, via the network 118. Also, the data transfer I/F 107 receives the data transmitted by the external apparatus and outputs the data to the CPU 102 and the like via the network 118.

With the configuration described above, the image processing apparatus 101 executes predetermined processing in accordance with a program stored in the HDD 104 on the image data received from the printing apparatus 108 via the data transfer I/F 107. The image processing apparatus 101 displays the program processing result and various pieces of information on a display (not illustrated) via the display I/F 105.

The printing apparatus 108 prints an image on a printing medium such as paper on the basis of the image data transmitted by the image processing apparatus 101. The printing apparatus 108 is an inkjet printing apparatus and may be referred to as an inkjet printer. The printing apparatus 108 is configured to be installed with a post-processing mechanism that executes a post-processing process on a printing medium printed with an image. The printing apparatus 108 includes a CPU 111, a RAM 112, a ROM 113, an image processing accelerator 109, a data transfer I/F 110, a print head controller 114, a print head 115, and a data buffer 119. At least a part of the CPU 111, the RAM 112, the ROM 113, the image processing accelerator 109, the data transfer I/F 110, the print head controller 114, the print head 115, and the data buffer 119 is a computer and an example of an information processing apparatus.

The CPU 111 is an example of a control unit and is a processor also referred to as a central processing unit. The printing apparatus 108, in addition to or instead of the CPU 111, may also include an MPU, a GPU, a QPU, or a similar processor. The CPU 111 reads out a program stored in the ROM 113, loads the program on the RAM 112 functioning as a working area, and executes various types of processing. For example, the CPU 111, in accordance with a command from the user, executes a program stored in the ROM 113 and controls the printing apparatus 108 to print an image on a printing medium on the basis of the image data transmitted by the image processing apparatus 101. The CPU 111 directly or indirectly controls the post-processing mechanism. A part or all of the various types of processing executed by the CPU 111 may be implemented using one or more circuits such as an ASIC and an FPGA.

The RAM 112 is an example of a storage unit, is an abbreviation of random access memory, and is a memory with high read and write speeds for data. The RAM 112 temporarily stores programs read out by the CPU 111 and temporarily stores data required to execute programs, data corresponding to program processing results, and the like.

The ROM 113 is an abbreviation of read-only memory and is a non-volatile memory that can store data without power being supplied. The ROM 113 stores programs, data required to execute programs, and the like.

The image processing accelerator 109 executes image processing at high-speeds. The image processing accelerator 109 is a piece of hardware that can execute image processing at higher speeds than the CPU 111. The image processing accelerator 109 may be a GPU, for example. The image processing accelerator 109 is activated by the CPU 111 writing the parameters and data required for image processing to a predetermined address of the RAM 112 and executes a predetermined image processing on the data after the parameters and data have been loaded. However, the image processing accelerator 109 is not a necessary component, and a similar processing can be executed by the CPU 111.

The data transfer I/F 110 is an interface that connects to the network 118. The data transfer I/F 110 receives data such as the image data output by the image processing apparatus 101 via the network 118.

The print head controller 114 controls the print head 115 and prints an image on the basis of an instruction from the CPU 111 or the like.

The print head 115 discharges ink onto a printing medium and prints an image on the basis of the control by the print head controller 114. The print head 115 discharges pigment ink of four colors. The four colors are KCMY (black, cyan, magenta, and yellow). The print head 115 includes a plurality of nozzle arrays 115k, 115c, 115m, 115y each including a plurality of nozzles. The discharge amount of each nozzle is 4 (pL), for example.

The data buffer 119 temporarily stores data. The data buffer 119 temporarily stores the image data transmitted by the image processing apparatus 101, for example.

The post-processing mechanism 116 executes a post-processing process on a printing medium printed with an image. The post-processing mechanism 116 includes a data transfer I/F 117. The post-processing mechanism 116 is detachably installed in the printing apparatus 108. The post-processing mechanism 116 is connected to a member that discharges a printing medium with an image printed by the printing apparatus 108, for example. In a state with the post-processing mechanism 116 installed in the printing apparatus 108, the data transfer I/F 117 is connected to the printing apparatus 108 in a manner allowing data such as commands to be transmitted and received. The post-processing mechanism 116, in an installed state in the printing apparatus 108, executes the post-processing process on the basis of an instruction or the like from the CPU 111 of the printing apparatus 108 received via the data transfer I/F 117. The post-processing process includes at least one of various types of post-processing processes including a stapling process to bind a plurality of printing medium with a printed image, a hole punching process to punch open holes in the printing medium, a sorting process for shift sorting, and the like.

### Image Processing Flow

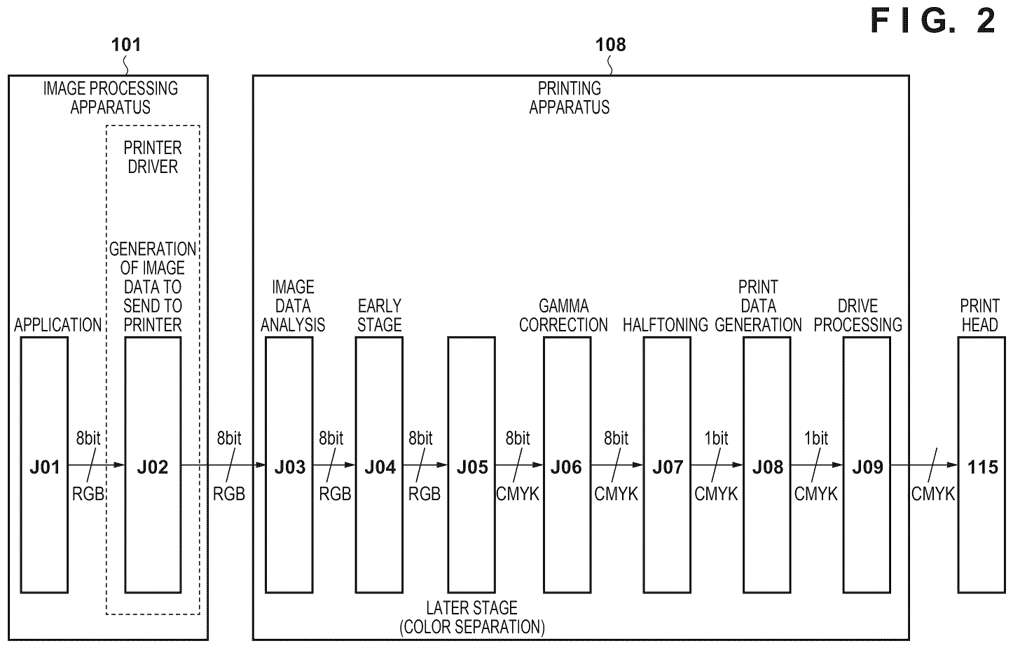

FIG. 2 is a block diagram illustrating the flow of image data conversion processing in the printing system according to the present embodiment. The image data conversion processing in the printing apparatus 108 will be described below.

The printing apparatus 108 according to the present embodiment prints using ink of four colors, cyan, magenta, yellow, and black. The print head 115 includes a nozzle array that discharges ink of the four colors. As illustrated in FIG. 2, each image process in the printing system is executed by the image processing apparatus 101 and the printing apparatus 108.

Programs that run on the operating system of the image processing apparatus 101 include applications, printer drivers, and the like. Applications and printer drivers are executed by the CPU 102. Examples of applications include applications for creating documents, applications for creating illustrations, and the like.

In application processing J01, the CPU 102 that executes the application generates image data corresponding to the image to be printed by the printing apparatus 108. The CPU 102 sends the image data generated in the application processing J01 to the printer driver.

In image data to send to printer generation processing J02, the CPU 102 executes the printer driver, generates image data, and transmits the image data to the printing apparatus 108. Specifically, the CPU 102 generates image data in a page-description language (PDL) format as image data. Hereinafter, image data in the PDL format will be referred to as PDL data. PDL is a page-description language. A known example of PDL is “PDF” from Adobe (registered trademark). PDL is widely used as an image format that can describe line and character vector data and not only bitmap. The CPU 102, by executing the printer driver, generates image data to send to printer of a PDL format from image data sent from an application. The CPU 102, by executing the printer driver, adds a header portion such as setting information relating to the printer set via a user interface (UI) of the image processing apparatus 101 and generates image data to send to printer. The CPU 102 controls the data transfer I/F 107 of the image processing apparatus 101 and transmits the image data to send to printer to the data transfer I/F 110 of the printing apparatus 108 via the network 118. The printing apparatus 108 stores the received image data in the data buffer 119.

In image data analysis processing J03, the CPU 111 (image processing unit) of the printing apparatus 108 analyzes the image data transmitted by the image processing apparatus 101. The CPU 111 sequentially reads out the PDL data from the data buffer 119. The CPU 111 interprets the render command included in the PDL data and develops the PDL data into raster image data with a format similar to bitmap. The CPU 111 stores the developed raster image data in the data buffer 119. The CPU 111 continues to execute image processing on the analyzed and developed raster image data.

The CPU 111 executes early stage processing J04 which is color conversion processing for color matching between models, later stage processing J05 which is color separation, gamma correction processing J06, halftoning processing J07 which is binary quantization, and print data generation processing J08. Here, each process will be simply described.

In the early stage processing J04, the CPU 111 executes color matching processing to match colors that are difference between models.

In the later stage processing J05, the CPU 111 executes color separation processing to convert the 8-bit data R, G, B obtained in the early stage processing J04 into color separated data (here, 8-bit data C, M, Y, K) corresponding to the combination of ink for reproducing the colors represented by the RGB data. Specifically, the CPU 111 uses a conversion table (for example, a three-dimensional look-up table (LUT)) in which the RGB data and the CMYK data corresponding to the ink are associated in a 1-to-1 relationship. The CPU 111 references the conversion table and converts the RGB data to CMYK data. For example, in the three-dimensional LUT, each value of R, G, and B represented by 8-bits (0 to 255) is associated in advance with a value of CMYK represented by 8-bits (0 to 255). The CPU 111, on the basis of the conversion table, converts image data of (R, G, B)=(0 to 255, 0 to 255, 0 to 255) to image data of (C, M, Y, K)=(0 to 255, 0 to 255, 0 to 255, 0 to 255). For example, the CPU 111 converts (R, G, B)=(0, 0, 0) to (C, M, Y, K)=(0, 0, 0, 255). The CPU 111 converts (R, G, B)=(255, 255, 255) to (C, M, Y, K)=(0, 0, 0, 0). The CPU 111 converts (R, G, B)=(0, 128, 0) to (C, M, Y, K)=(128, 0, 128, 0).

In the present embodiment, a plurality of conversion tables are preset and stored in the ROM 113. For example, at least two types of conversion tables are provided. The CPU 111 switches between the conversion table to use according to a predetermined condition. This will be described below in detail.

In the gamma correction processing J06, the CPU 111 executes tone value conversion on the data of each ink color of the color separation data obtained in the later stage processing J05 which is color separation processing. Specifically, the CPU 111 uses a one-dimensional LUT corresponding to the tone characteristics of each color ink of the printing apparatus 108 to execute conversion so that the color separation data is linearly associated with the tone characteristics of the printing apparatus 108.

In the halftoning processing J07, the CPU 111 executes quantization processing to convert each piece of 8-bit color separation data C, M, Y, K into 1-bit data. In the present embodiment, the CPU 111 uses a binary dithering method to convert the 8-bit data of 256 tones to 1-bit data of 2 tones.

In the print data generation processing J08, the CPU 111 generates print data with print control information added to the print image data containing 1-bit dot data. The CPU 111 stores the generated print data in the data buffer 119.

In drive processing J09, the CPU 111 sequentially reads out the binary print data stored in the data buffer 119 and sends the print data to the print head controller 114. The print head controller 114 converts the 1-bit data of each color into a drive pulse of the print head 115 and outputs the drive pulse. In this manner, the print head 115 discharges ink at a predetermined timing.

### Printing Apparatus Details

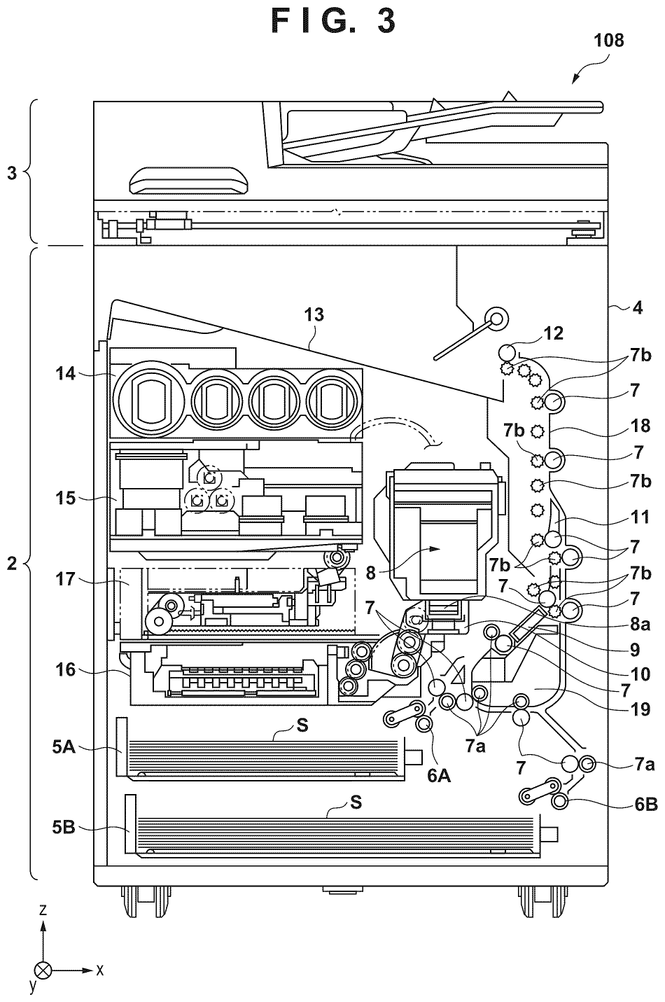

FIG. 3 is a diagram illustrating in detail the overall configuration of the printing apparatus 108 according to the present embodiment. The printing apparatus 108 will be described below in detail. Hereinafter, the xyz directions indicate the xyz direction indicated by the arrows at the bottom left of FIG. 3.

The printing apparatus 108 is a multi-function peripheral that executes various types of processing relating to image printing operations and image reading operations. The printing apparatus 108 includes a printing unit 2 and a scanner unit 3. The printing apparatus 108 executes various types of operations by separately or cooperatively driving the printing unit 2 and the scanner unit 3. FIG. 3 illustrates the printing apparatus 108 in a standby state in which neither a printing operation or a reading operation is being performed. Note that the printing apparatus 108 according to the present embodiment is a multi-function peripheral including both the printing unit 2 and the scanner unit 3, but in another embodiment, the scanner unit 3 may not be provided.

The scanner unit 3 includes an automatic document feeder (ADF) and a flat bed scanner (FBS). The ADF automatically feeds documents. The FBS reads (scans) documents automatically fed to it and documents placed on a platen of the FBS by the user.

The printing unit 2 includes a casing 4, a first cassette 5A, a second cassette 5B, a first feeding unit 6A, a second feeding unit 6B, one or more conveyance rollers 7, one or more pinch rollers 7a, one or more spurs 7b, a flapper 11, a discharge roller 12, a discharge tray 13, a guide 18, and an inner guide 19.

The casing 4 houses and holds the members of the printing unit 2.

The first cassette 5A and the second cassette 5B are detachably installed in the bottom portion of the casing 4 in the vertical direction. The first cassette 5A and the second cassette 5B house printing medium S such as cut sheets. The first cassette 5A houses relatively small printing medium up to the A4 size in a stack. The second cassette 5B houses relatively larger printing medium up to the A3 size in a stack.

The first feeding unit 6A is provided near the first cassette 5A. The second feeding unit 6B is provided near the second cassette 5B. The first feeding unit 6A and the second feeding unit 6B feed the housed printing medium separating them one at a time. When a printing operation is performed, one of the feeding units 6A and 6B selectively feeds the printing medium S from one of the cassettes 5A and 5B.

The conveyance rollers 7, the pinch rollers 7a, the spurs 7b, the flapper 11, the discharge roller 12, the discharge tray 13, the guide 18, and the inner guide 19 correspond to a conveying mechanism for conveying the printing medium S in a predetermined direction. Upstream and downstream used in the following description indication upstream and downstream with respect to the conveyance path of the printing medium S.

The plurality of conveyance rollers 7 are disposed along the conveyance path on the upstream side and the downstream side of a print head 8 and a platen 9. The conveyance rollers 7 are driving rollers that are rotationally driven by a conveyance motor.

The pinch rollers 7a are disposed on the downstream side of both the feeding units 6A and 6B. The pinch rollers 7a nip the printing medium S fed from the feeding units 6A and 6B together with the conveyance rollers 7. The pinch rollers 7a are driven rollers that rotate in conjunction with the rotation of the conveyance rollers 7.

The plurality of spurs 7b are disposed along the conveyance path on the downstream side of the print head 8 and the platen 9. The spurs 7b with the conveyance rollers 7 or the discharge roller 12 hold the printing medium S between them and convey the printing medium S.

The flapper 11 is a member for switching the direction in which the printing medium S is conveyed in the case of a double-sided printing operation in which an image is printed on both sides of the printing medium S.

The guide 18 is provided along the conveyance path of the printing medium S. The guide 18 guides the printing medium S conveyed by the conveyance rollers 7 and the like along the conveyance path.

The inner guide 19 is disposed near the pinch rollers 7a and includes a side surface that is curved as the member extends in the y direction. The inner guide 19 guides the printing medium S along the side surface.

The discharge roller 12 is disposed on the downstream side of the conveyance path downstream from the conveyance rollers 7. The discharge roller 12 is a driving roller that is driven by a discharge motor. The discharge roller 12 discharges the printing medium S conveyed along the conveyance path to the discharge tray 13.

The printing medium S discharged by the discharge roller 12 after the printing operation is complete is stacked in the discharge tray 13. The discharge tray 13 is an example of a discharge unit.

The printing unit 2 further includes the print head 8, the platen 9, an ink tank unit 14, an ink supply unit 15, and a maintenance unit 16.

The print head 8 according to the present embodiment is a full line type color inkjet print head. The print head 8 includes a plurality of discharge ports that discharge ink in accordance with the print data. The plurality of discharge ports are arranged to correspond with the width of the printing medium S in the y direction. When the print head 8 is in the standby position, a discharge port surface 8a of the print head 8 is orientated downward (−z direction) in the vertical as illustrated in FIG. 3 and is capped by a cap unit 10. When a printing operation is performed, the orientation of the print head 8 is changed by the CPU 111 so that the discharge port surface 8a is positioned opposite the platen 9.

The platen 9 includes a flat plate extending in the y direction and is disposed in the middle portion of the conveyance path. In a printing operation, the platen 9 is positioned opposite the discharge port surface 8a of the print head 8 and supports the printing medium S from the back surface for the printing operation to be performed by the print head 8.

The ink tank unit 14 stores the four colors of ink supplied to the print head 8.

The ink supply unit 15 is provided in the middle portion of the flow path connecting the ink tank unit 14 and the print head 8 and adjusts the pressure and the flow rate of the ink in the print head 8 within an appropriate range. In the present embodiment, a circulation ink supply system is used. Accordingly, the ink supply unit 15 adjusts the pressure of the ink supplied to the print head 8 and the flow rate of the ink collected from the print head 8 within an appropriate range.

The maintenance unit 16 includes the cap unit 10 and a wiping unit 17. The maintenance unit 16 causes the cap unit 10 and the wiping unit 17 to operate at a predetermined timing and executes maintenance for maintaining and recovering the discharge performance of the print head 8. The cap unit 10 operates at a predetermined timing to cap the discharge port surface 8a. The wiping unit 17 cleans the discharge port surface 8a of the print head 8.

### Post-Processing Mechanism

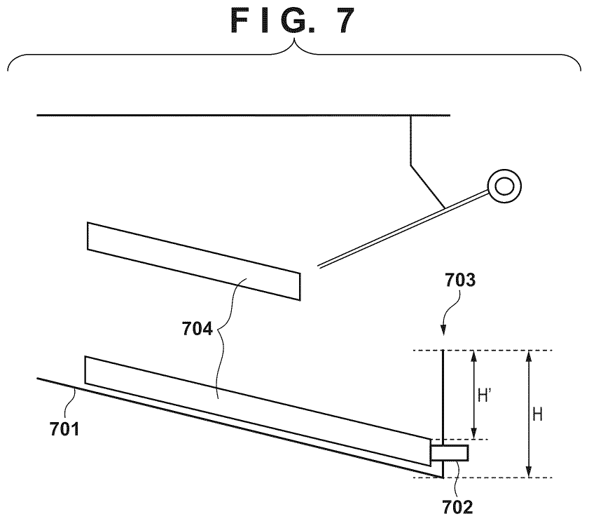

The post-processing mechanism can be installed at the discharge tray of the printing apparatus 108 or near the discharge tray. Accordingly, the user can use the post-processing process without increasing the footprint. FIG. 7 is a diagram of the area near the discharge unit of FIG. 3 installed with a post-processing mechanism 704.

The post-processing mechanism 704 is installed aligned with a discharge tray 701, and a sensor 702 can determine whether or not it is installed. The post-processing mechanism will now be described. The functions of the post-processing mechanism include a shift sort function, a punch function, and a staple function.

The shift sort function is a mechanism that shifts the paper stack for each set so that the paper stacks can be separated at each set after the finishing. The details will be described below, but after printing, the water content is applied to the media print surface side of the printing medium S and the hydrogen bonds of the media break causing swelling. This makes the printing medium S curl with the curve of the print surface side pointing upward. In this post-discharge curled state, the subsequent printing medium S is discharged onto the preceding printing medium S on the discharge tray. With no sorting, the left-right discharge positions are aligned, and the printing medium S may bump into each other without causing a paper jam. With shift sorting, the subsequent printing medium S runs into the preceding printing medium S with post-discharge curling with the curve on the lower side at the shifted position, and the pieces of printing medium S bump into each other. The collision between the printing medium S makes jamming more likely.

The staple function is a function for automatically stapling together the printing medium S. Regarding meeting material, proposal material, and the like, by using the staple function when material needs to be created by stapling together a plurality of sheets of the printing medium S, the amount of time taken to create the material can be greatly reduced. In the case of using the staple function, the bundle of the printing medium S is fixed with the offset unchanged, causing a bad appearance. Thus, there is a demand for better alignment. Also, the plurality of printing medium S needs to be put in the narrow opening of a stapler, and so even a small amount of curl may cause jamming.

The punch function is a function for opening a punch hole in the printed printing medium S. The opened punch hole is a hole for filing the printing medium S as a stack using rings or the like. In the case of filing, if the offset amount is large, the post-filing alignment of the printing medium S is degraded. Thus, there is a demand for better alignment. Also, the plurality of printing medium S needs to be put in the narrow opening of a puncher, and so even a small amount of curl may cause jamming.

### Print Settings

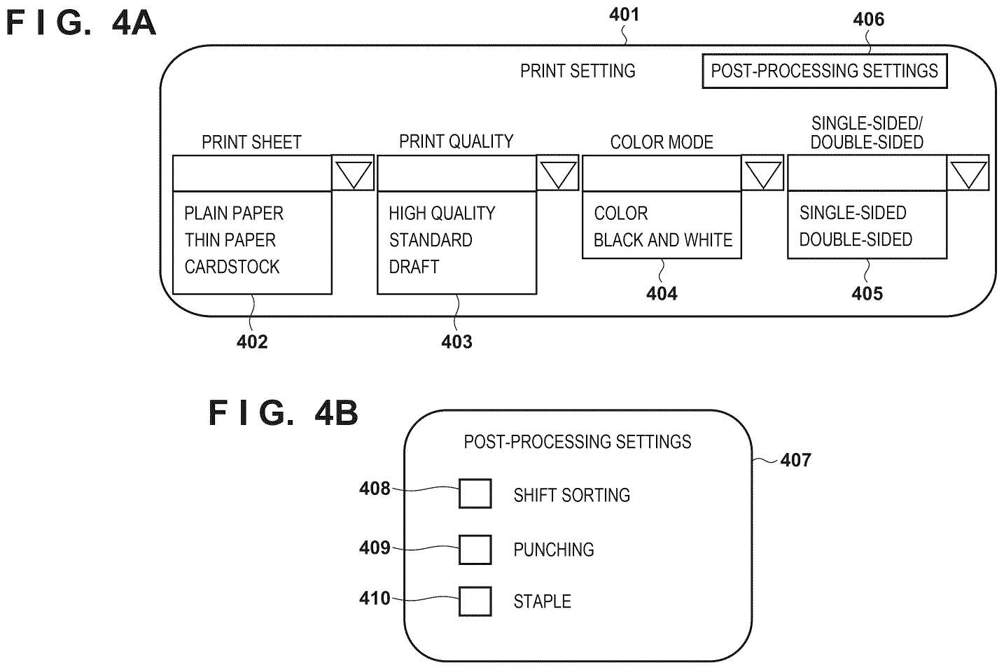

FIG. 4A illustrates a print setting UI 401 operated by the user to set the print setting of the printing apparatus. The print settings may also be referred to as printing settings. FIG. 4B illustrates a post-processing process selection UI 407 for setting the post-processing process. UI is an abbreviation for user interface.

As illustrated in FIG. 4A, the following selections are possible via the print setting UI 401 operated by the user when issuing print setting instructions to the printing apparatus 108. For example, the user selects, via the print setting UI 401, settings including a print sheet type selection 402, a print quality setting 403, a color mode 404, a single-sided/double-sided setting 405, and the like. Here, print sheet setting is where the printing medium such as plain paper, thin paper, cardstock, or the like is set. The print quality setting is where the different print quality or speeds such as high quality, standard, draft, and the like is set. The color mode setting is where either color printing or black and white printing is set. The single-sided/double-sided setting is where with single-sided printing or double-sided printing is designated.

### Post-Processing Settings

As illustrated in FIG. 4A, the print setting UI 401 includes a post-processing settings button 406. The post-processing settings button 406 can only be selected when it is determined that a post-processing mechanism is installed by the sensor 702. When the user selects the post-processing settings button 406, the post-processing process selection UI 407 is displayed as illustrated in FIG. 4B. The displayed post-processing process selection UI 407 includes a shift sorting checkbox 408, a punch function checkbox 409, and a staple function checkbox 410. The user selects the desired post-processing process via the post-processing process selection UI 407. The post-processing mechanism executes the post-processing process in accordance with the selection instruction.

### Why Curling Occurs

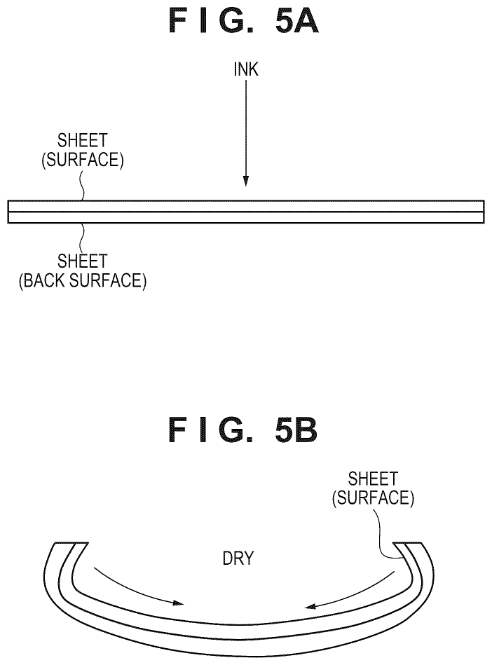

FIGS. 5A and 5B is a diagram schematically illustrating a printing medium at the time of single-sided printing in a curled state. FIG. 5A illustrates the printing medium before printing. FIG. 5B illustrates the printing medium after printing in a curled state.

Inkjet printing apparatuses commonly use a water-based ink. Thus, as illustrated in FIG. 5A, ink is discharged onto only one side of the sheet (printing medium). When an image is printed on only one side, the water content (ink solvent component) permeates into the fibers of the sheet. Accordingly, the front surface side of the sheet swells, and the sheet rises up on the front surface side. Thereafter, the water content permeated into the fibers of the sheet evaporates, and the front surface side contracts more than before printing. As a result, as illustrated in FIG. 5B, the sheet curls with the front surface which is the printed surface becoming the inner side.

The mechanism behind curling will now be described in further detail. When water content is applied to the sheet, the hydrogen bonds formed between the cellulose fiber of the sheet are broken. In other words, the water content being applied causes the cellulose to swell and a chemical phenomenon. At this time, the ink permeates in the depth direction of the sheet in a non-uniform manner, with the ink amount being less in deeper portions. Portions filled with ink, that is, the fiber at portions in contact with water, swell. Accordingly, a negative curl is caused with the surface where the water content is applied curls, curving to the opposite side. However, as the absorbed water content in the cellulose evaporates, the cellulose begins to contract and the hydrogen bonds that were broken reform. At this time, the hydrogen bonds reform not at the position where they were broken, but at a different position. Thus, positive curling occurs with the sheet curling gradually in the direction of the surface where the water content is applied.

Positive curling indicates a state in which the back surface bends to the surface side and the curve is pointing downward on the front surface side, and negative curling indicate a state in which the front bends to the back surface side and the curve is pointing upward on the front surface side. In particular, in the case of inkjet printing on plain paper or the like, positive curling can be problematic. If positive curling occurs, the discharged printing medium may be misaligned or a paper jam may occur.

### Curling and Jamming

The phenomenon of paper jamming when a printing medium with a curl is discharged will now be described in further detail.

When printing using an inkjet system, the amount of curling that occurs in a printing medium changes depending on the image printing duty cycle or the ejection amount of ink (applied amount). In particular, when the applied amount of ink is large, the printing medium after printing tends to curl greatly. Also, even in the case of low temperatures and low humidity, the curl tends to be large in a similar manner. Thus, if the printing medium with a large curl is continued to be conveyed as is and discharged to the discharge tray of the printing apparatus, the printing medium changes from a state in which the curl in restricted in the conveying path to a state in which the restriction is lifted. This makes the curl of the printing medium larger. Alternatively, if the printing medium is discharged to the discharge tray with the curl of the printing medium in an unstable state, the printing medium may deform greatly thereafter.

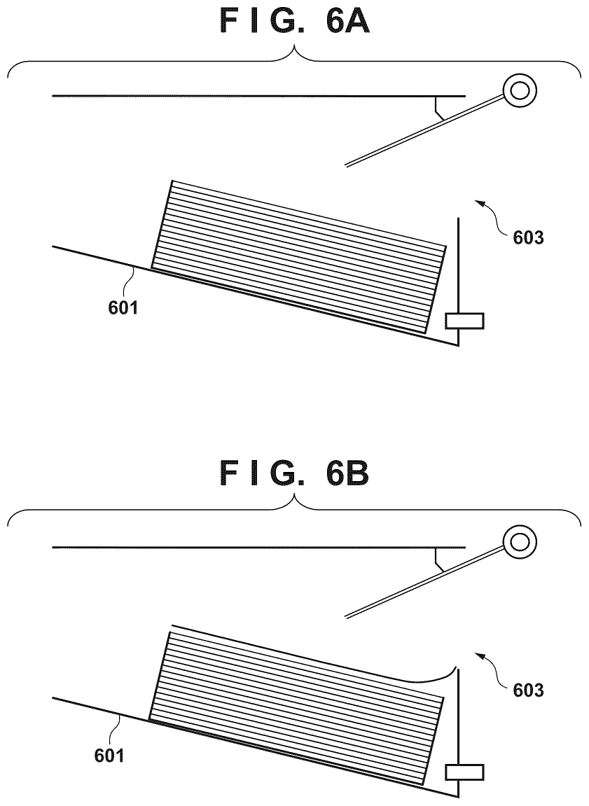

FIGS. 6A and 6B are diagrams for describing deformation of the printing medium in the discharge tray. FIG. 6A is a diagram illustrating the state of the printing medium discharged into the discharge tray. FIG. 6B is diagram schematically illustrating the state of the preceding printing medium placed in the discharge tray being curled up and, in this state, a subsequent printing medium is discharged.

In a case where the printing medium does not have a curl as illustrated in FIG. 6A, even if the preceding printing medium is placed in the discharge tray, the subsequent printing medium discharged from a discharge port 603 does not come into contact with the preceding printing medium.

In a case where the subsequent printing medium is discharged from the discharge port 603 with the preceding printing medium placed on a discharge tray 601 curled up as illustrated in FIG. 6B, the subsequent printing medium comes into contact with the preceding printing medium. As a result, the subsequent printing medium is pushed upward and deforms, causing a paper jam.

If the curl of the preceding printing medium decreases over time to a height lower than the discharge position and stays in this state, the subsequent printing medium is discharged without coming into contact with the preceding printing medium, and a paper jam does not occur.

### Post-Processing Mechanism and Paper Jam

A paper jam in the case of a post-processing mechanism will now be described using FIG. 7. A height H indicates the height from the lower end of a discharge port 703 before the post-processing mechanism 704 is installed to the discharge tray 701. A height H′ indicates the height from the lower end of the discharge port 703 after the post-processing mechanism 704 is installed to the discharge position of the post-processing mechanism 704. As can be seen from FIG. 7, by installing the post-processing mechanism 704, the height H′ for stacking at the discharge unit is smaller. As described above, printing may cause curling to occur. In a case where the post-processing mechanism 704 is installed, since the stack height H′ is smaller, the curl amount needs to be reduced more than in a case where the post-processing mechanism 704 is not installed to make paper jam less likely to occur.

### Ejection Amount and Curling

When the amount of water content applied per unit area of the sheet surface is large, the permeation depth of the water content into the sheet surface is deep. Since the hydrogen bonds in the sheet surface depth direction are broken and the number of fibers involved in curling are increased, we know that the degree of curling increases according to the ejection amount.

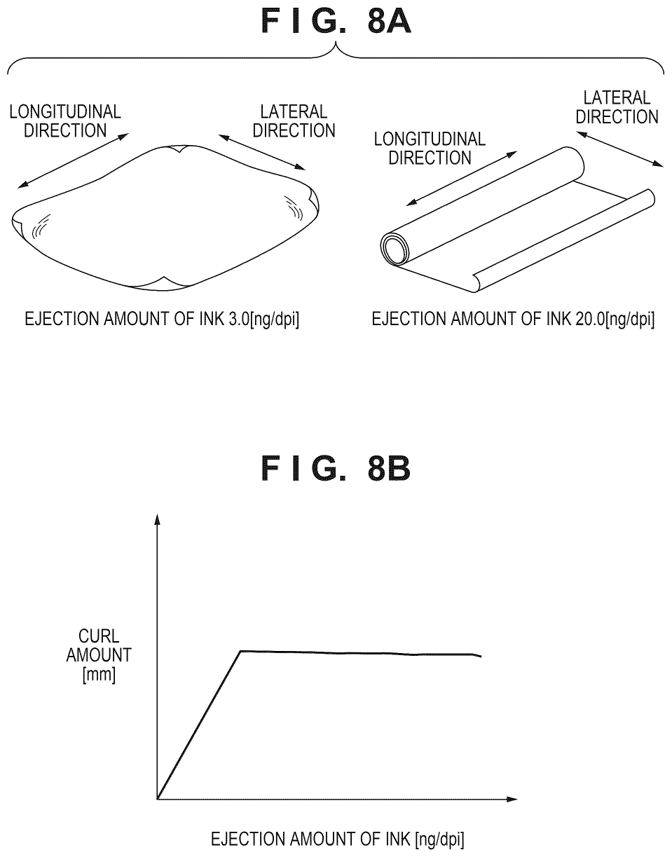

The relationship between the ejection amount of ink and the curl amount will be described in detail below. FIGS. 8A and 8B are diagrams illustrating the relationship between the ejection amount of ink and curling.

FIG. 8A is a diagram illustrating the direction that the sheet tends to curl. As described above, paper, which is a printing medium, has a fiber direction (also referred to as the grain of the paper). Here, the paper according to the present embodiment is made with the fibers aligned in the longitudinal direction. In this case, the paper is more likely to curl in the lateral direction. In particular, when the ejection amount of ink is small (for example, 3.0 ng/dpi), the curled state in the longitudinal direction and the curled state in the lateral direction are roughly the same. However, when the ejection amount of ink is large (for example, 20.0 ng/dpi), curling in the lateral direction tends to occur more than in the lateral direction.

FIG. 8B is a diagram illustrating the result of examining the relationship between the ejection amount of ink and the initial curling (curl) amount using the following method.

An inkjet printing apparatus is used as a printing apparatus, a solid color is printed on a plain paper at a constant ink amount, and the curl amount is measured immediately after the plain paper is discharged from the printing apparatus. In the curl amount measurement, the time when printing ends is defined as 0, after discharge, the printed surface is laid face down, the maximum height (H) of a back curl in which the ends of the paper curl up is measured at four points, and the average value is obtained and evaluated.

As can be seen from FIG. 8B, at a region where the ejection amount of ink is low, the curl amount increases as the ejection amount of ink increases. However, when the ejection amount of ink increases to a certain level, the curl amount becomes a substantially constant value.

The reason for this behavior is that the curling is determined by the difference in the elongation (stretching) of the paper between the front and back sides. Thus, while the ejection amount of ink is small, the paper elongation is great and the curl amount gradually increases. However, when the ejection amount of ink exceeds a certain amount, the water content amount permeating into the paper increases, and the difference in the elongation (stretching) of the paper between the front and back sides actually decreases, making the curl amount stop changing.

### Speed and Curling

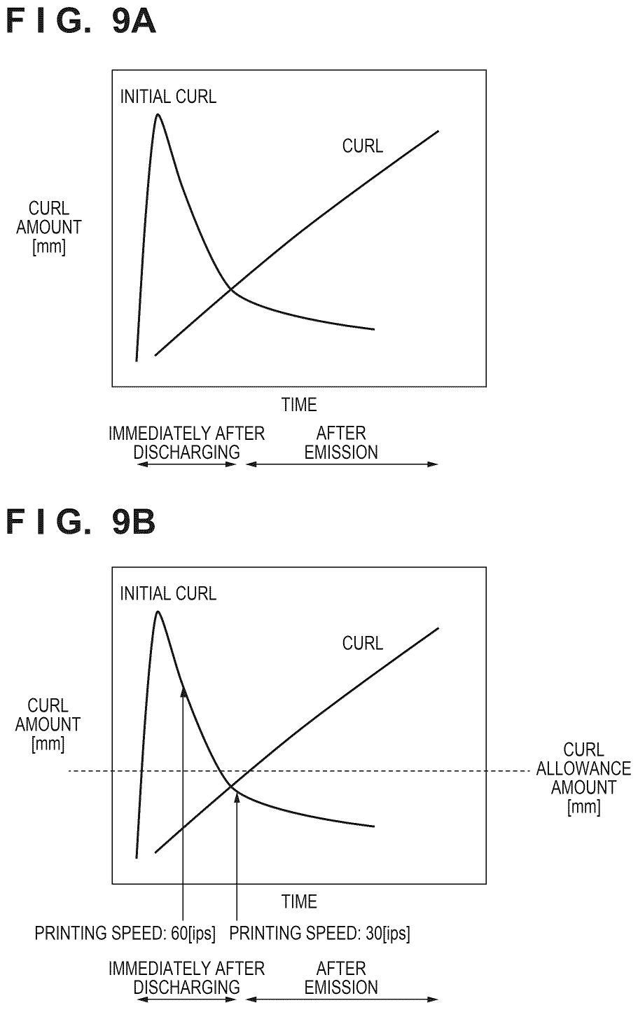

The relationship between the post-printing elapsed time and the curl amount will be described in detail below. FIGS. 9A and 9B are diagrams illustrating the relationship between the printing time and the curl amount.

FIG. 9A is a diagram illustrating the relationship between the post-printing elapsed time and the curl amount. In the schematic diagram, the horizontal axis represents the amount of time that has elapsed since ink has been applied, and the vertical axis represents the curl amount. The initial curl amount is the amount of curl from the print surface rising up due to the paper fibers swelling in reaction to the ink water content immediately after printing. The final curl amount is the amount of curl from the print surface being on the inner side due to the water content in the sheet evaporating and the surface shrinking.

The method for measuring the curl amount is similar to that described above and is performed by printing a solid color on a plain paper at a constant ink amount and measuring the change amount from immediately after the plain paper is discharged from the printer.

As can be seen from FIG. 9A, the initial curl amount immediately after ink is applied is large, and as time passes, the initial curl amount decreases. However, the final curl amount shows a tendency to increase as time passes. The reason for this behavior is that immediately after printing, the sheet curls with the front surface side rising up due to swelling on the front surface side of the sheet. Thereafter, the water content that permeated into the sheet evaporates, and the front surface contracts more than before printing, causing the sheet to curl with the print surface becoming the inner side.

An example of a method for solving this problem includes delaying the discharge of paper until the maximum value of the initial curl amount of the preceding printing medium is lower than the position of the discharge port of the discharge tray inside the printing apparatus. This suppresses paper jamming due to contact with the subsequent printing medium. Also, the paper is preferably discharged before the final curl amount increases above a predetermined curl allowance amount described below. In other words, the paper may be discharged in a time period in which the initial curl amount and the final curl amount are equal to or less than the curl allowance amount.

FIG. 9B is a diagram illustrating the result of examining the relationship between the printing speed and the curl amount using the following method. The printing speed may also be referred to as the print speed. In the schematic diagram, the horizontal axis represents the amount of time that has elapsed since ink has been applied, and the vertical axis represents the curl amount. Note that the immediately after discharge of ink and after discharge of paper displayed below the horizontal axis are of the draft mode.

Also, curl amount indicated is in the case of printing with the printing speed according to the present embodiment being 60 (ips) in standard mode and 30 (ips) in draft mode. It can be seen that in standard mode, the initial curl amount is greater than the curl allowance amount indicated by the 60 (ips) arrow. The 60 (ips) arrow indicates the paper discharge time in standard mode.

For example, in a case where printing is continued in the standard mode without changing the printing speed, depending on the ejection amount of ink of the print sample, the initial curl amount at the time of paper discharge exceeds the curl allowance amount. Thus, the subsequent printing medium comes into contact with the preceding printing medium, causing a paper jam.

If the initial curl amount of the preceding printing medium decreases over time to a height lower than the discharge position and stays in this state, the subsequent printing medium is discharged without coming into contact with the preceding printing medium, and a paper jam does not occur.

By decreasing the printing speed, the amount of time from the start of printing to paper discharge can be extended, which can help suppress the initial curl amount after paper discharge. In other words, in the draft mode with a slow printing speed, as indicated by the 30 (ips) arrow, when the paper is discharged, the initial curl amount is less than the curl allowance amount.

Accordingly, the printing speed may be set from the relationship between the printing speed described above and the curl amount.

### Printing Operations When Setting Post-Processing Process Function

An example of operations performed regarding the installation of a post-processing mechanism and the decrease of curling when setting the post-processing process will be described, building on what has been described above.

As described above, installing a post-processing mechanism makes the discharge port narrower, which makes paper jams more likely. Thus, the curl amount after printing needs to be decreased more in the case of the post-processing mechanism being installed than in the case of the post-processing mechanism not being installed. For example, in an example of a method for reducing the curl amount, the CPU 111 may reduce the printing duty cycle. The printing duty cycle may be the density of the image printed on the printing medium, for example. In this case, the CPU 111 may display a UI warning that the print density will be reduced if the printing duty cycle is reduced. Examples of a method for reducing the curl amount include a method in which the CPU 111 performs adjustment to reduce the printing speed (print speed) as described above and a method in which the CPU 111 performs adjustment to extend the printing time (print time). At this time, the printing speed and the printing time can be adjusted by changing the waiting time during printing, changing the carriage scanning speed, or increasing the length of the print path. In a case where the curl amount is reduced by increasing the printing time, the CPU 111 may perform adjustment to increase the waiting time during printing. As a method for reducing the curl amount, reducing the applied amount of ink can also be performed as described above. In a case where the post-processing process is set, the curl amount can be reduced by executing these methods. Also, a combination of these methods may be used to reduce paper jams.

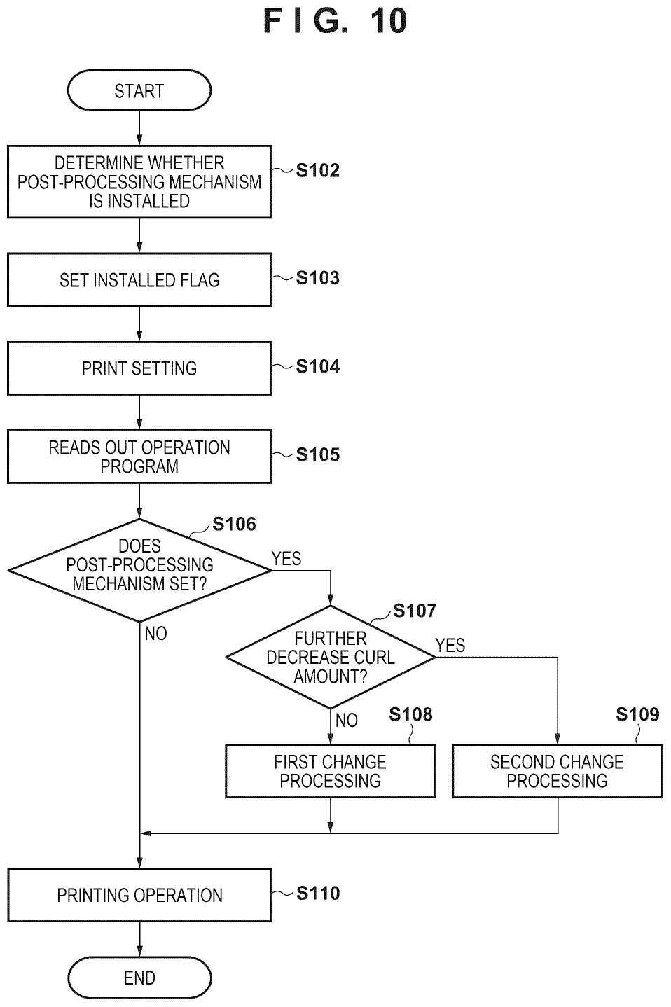

Building on what has been described above, the operations of the printing apparatus 108 when a post-processing process is applied will now be described. FIG. 10 is a diagram of a flowchart illustrating the printing processing of the printing apparatus 108.

In step S102, the CPU 111 determines whether or not a post-processing mechanism is installed. For example, the CPU 111 may determine this on the basis of a detection signal from the sensor 702 illustrated in FIG. 7.

In step S103, the CPU 111 sets a post-processing mechanism installed flag held in the RAM 112. Here, the installed flag being ON indicates that a post-processing mechanism is installed, and OFF indicates that a post-processing mechanism is not installed. Thus, in a case where the CPU 111 determines that a post-processing mechanism is installed on the basis of a detection signal from the sensor 702, the installed flag is set to ON. On the other hand, in a case where the CPU 111 determines that a post-processing mechanism is not installed, the installed flag is set to OFF. Note that in a case where the installed flag in ON, the user can select the post-processing settings button 406 in the print setting UI 401.

In step S104, the CPU 111 displays the print setting UI 401 and receives a print setting instruction from the user. In a case where the installed flag is ON, the CPU 111 displays the post-processing settings button 406 on the print setting UI 401. In a case where the user selects the post-processing settings button 406, the CPU 111 switches the display to the post-processing process selection UI 407. The CPU 111 receives a selection instruction of the post-processing process selected by the user on the post-processing process selection UI 407. The CPU 111 stores the received print setting in the RAM 112.

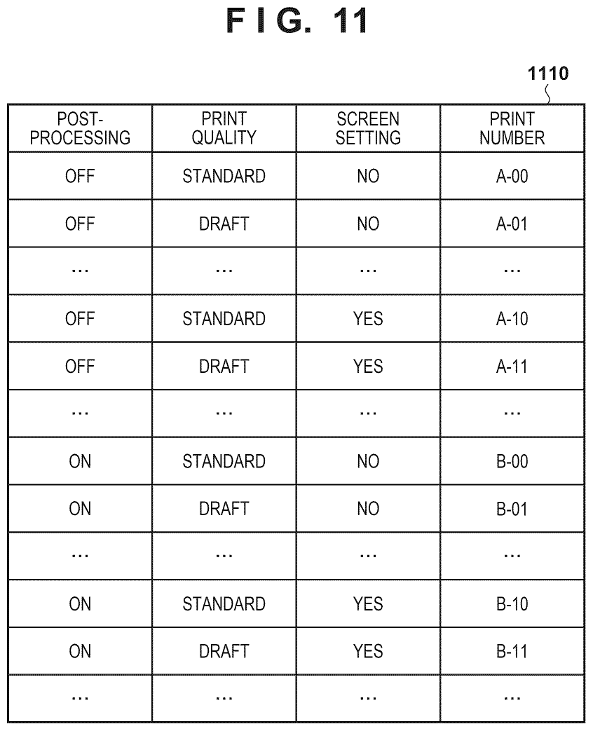

In step S105, in accordance with the print setting obtained in step $104, the CPU 111 references a printing operation table 1110 of the ROM 113, reads out the corresponding printing operation program, and loads this on the RAM 112. In this manner, the CPU 111 executes a printing operation in accordance with the user print setting. FIG. 11 is a diagram of the printing operation table 1110. The printing operation table 1110 includes a print number indicating a printing operation associated with a combination of post-processing and a print setting. The print setting includes anti-curling strength, print quality, double-sided setting, and the like.

In step S106, the CPU 111 determines whether or not a post-processing process is set. When the CPU 111 determines that a post-processing process is not set, the CPU 111 proceeds to step S110. When the CPU 111 determines that a post-processing process is set, the CPU 111 proceeds to step S107.

In step S107, the CPU 111 determines whether or not the set post-processing process needs to further reduce the curl amount. For example, in a case where a stapling processing for which alignment is more important compared to shift sorting processing is set, the CPU 111 determines that the curl amount needs to be further reduced. Note that the CPU 111 may determine whether or not the curl amount needs to be reduced using a table or the like in which post-processing processes and the required curl amount are associated together, for example. In a case where the CPU 111 determines that the curl amount does not need to be further reduced, the CPU 111 proceeds to step S108. In a case where the CPU 111 determines that the curl amount does need to be further reduced, the CPU 111 proceeds to step S109.

In step S108, the CPU 111 changes the print setting via first change processing. Specifically, the CPU 111 changes the print setting so that the printing medium is discharged in a state with a reduced curl amount compared to if a post-processing process is not set.

In step S109, the CPU 111 changes the print setting via second change processing. Specifically, the CPU 111 changes the print setting so that the printing medium is discharged in a state with a further reduced curl amount compared to the print setting via the first change processing.

### Print Settings

Changing the print setting in a case where a post-processing process is set will now be described using FIG. 11.

For example, in single-sided printing as illustrated in FIG. 11, in a case where the post-processing setting is OFF and the standard mode is selected as the print mode, print number A-00 is selected, and in a case where the post-processing setting is ON and the standard mode is selected, print number B-00 is selected. Also, a printing operation program is set so that printing is performed with a printing time of t (sec) for print number A-00 and a printing time of t′ (sec) for print number B-00. At this time, the relationship t′ (sec)>t (sec) is true, and the printing speed is reduced if the post-processing setting is ON. Thus, the curl amount at the time of discharge is suppressed. Alternatively, the curl amount at the time of discharge may be suppressed by setting the printing operation of print number B-00 with less amount of ink used compared to the printing operation of print number A-00. For example, in the case of print number A-00, operations are performed to print at 10.0 ng/600 dpi, and in the case of print number B-00, operations are performed to print at 5.0 ng/600 dpi.

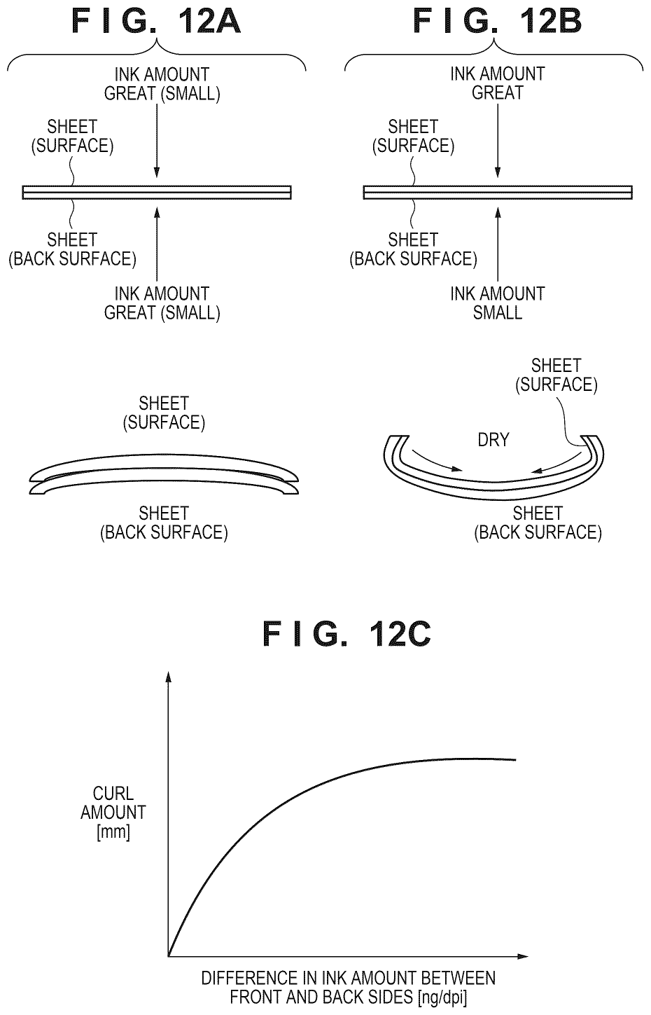

Also, the curl amount is suppressed more with the double-sided printing operation of print number B-10 compared to the single-sided printing operation of print number A-00. Here, curling in the case of double-sided printing will be described. FIGS. 12A to 12C are diagrams for describing curling of the printing medium when double-sided printing is performed. FIG. 12A is a diagram for describing curling when there is no difference in the ink amount between the front and back sides. FIG. 12B is a diagram for describing curling when there is a difference in the ink amount between the front and back sides. FIG. 12C is a diagram illustrating the relationship between the difference in the ink amount between the front and back sides and the curl amount. In FIG. 12C, the horizontal axis represents the difference in the ink amount between the front and back sides (ng/dpi), and the vertical axis represents the curl amount (mm).

As illustrated in FIG. 12A, in a case where the difference in the ink amount between the front and back sides is small, the difference in the swelling of the cellulose between the front and back sides of the printing medium is small. Thus, the curl amount is small. On the other hand, as illustrated in FIG. 12B, in a case where the difference in the ink amount between the front and back sides is large, the difference in the swelling of the cellulose between the front and back sides of the printing medium is large. Thus, the curl amount is large. As illustrated in FIG. 12C, when the difference in the ink amount between the front and back sides of the printing medium is large, the curl amount is large. However, if the difference in the ink amount is equal to or greater than a certain value, the curl amount hardly changes. In other words, compared to single-sided printing, double-sided printing produces a smaller curl amount due to the larger the difference in the ink amount between the front and back sides meaning the larger the curl amount. Thus, compared to single-sided printing, paper jams tend to occur less with double-sided printing.

As described above, in order to discharge paper in a state with reduced curling due to reducing the printing speed, reducing the ink application amount, and the like, the CPU 111, in a case where a post-processing process is set, may change the print setting on the basis of the post-processing process type, combination, or the like and may further reduce the curl amount at the time of discharge. For example, in a case where, from among the post-processing processes, the stapling processing places that most importance on alignment and the curl amount needs to be further reduced, compared to the print setting for shift sorting processing, the CPU 111 may further increase the print setting reduction amount, may make it double-sided printing, may further reduce the ink application amount, or the like to change the print setting and further reduce the curl amount.

In this manner, since the curl amount at the time of discharge is different depending on whether a post-processing process is set or a post-processing process is not set, the CPU 111 changes the print setting. Specifically, in a case where a post-processing process is set, compared to a case where a post-processing process is not set, the CPU 111 sets the print setting so that a printing medium is discharged in a state with a reduced curl amount. Also, even in a case where a post-processing process is set, the CPU 111 sets the print setting so that the curl amount is different at the time of discharge depending on the post-processing process type. For example, in a post-processing process for which alignment is more important, the CPU 111 sets the print setting so that paper is discharged in a state with a further reduced curl amount compared to when executing a post-processing process for which alignment is not important.

After the CPU 111 executes step S108 or step S109, the CPU 111 proceeds to step S110.

In step S110, the CPU 111 executes the printing operation. For example, in a case where a post-processing process is not set, the CPU 111 executes a printing operation on the basis of the print setting set in step S104, and in a case where a post-processing process is set, the CPU 111 executes a printing operation using the print setting changed to in either step S108 or step S109.

As described above, according to the present embodiment, in a case where a post-processing process is set, the print setting is changed so that paper is discharged in a state with a reduced curl amount. This can reduce paper jams. Furthermore, according to the present embodiment, in a case where a post-processing process can be selected from a plurality of post-processing processes, the print setting is changed depending on the post-processing process type so that the curl amount is further reduced. Thus, according to the present embodiment, paper jamming can be further suppressed and the curl amount can be appropriately reduced. This can reduce unnecessary processing, for example, increasing the printing time, for reducing the curl amount. In other words, according to the present embodiment, on the basis of the post-processing process type, the curl amount can be more appropriately reduced and paper jamming can be reduced.

### Second Embodiment

In the first embodiment described above, when a post-processing process is applied, the printing speed, the ink application amount, or the like is reduced to reduce paper jamming due to a post-processing process. However, the action of lowering the printing speed may lead to a reduction in productivity. Also, reducing the ink application amount may lead to a reduction in image quality. Accordingly, if the printing time is increased or the image quality is reduced at the same time as the post-processing process setting is turned on, the user may be confused and think that the wrong print setting was used or that the printer is faulty, reducing the user-friendliness. In light of this, in a case where a post-processing process setting is turned on, a display indicating the execution of an action to reducing jamming is displayed in a driver UI or the like. This can help prevent user confusion and can improve user-friendliness. Hereinafter, similar configurations to that in the first embodiment will not be described, and the actual operations will be described.

### UI Display When Setting Post-Processing Process

The actual flow will be described using FIG. 10. First, as illustrated in FIG. 7, the post-processing mechanism is put in an installed state by the user at the discharge tray of the printing apparatus. In step S102, the CPU 111 determines whether or not a post-processing mechanism is installed. The CPU 111 determines whether or not a post-processing mechanism is installed on the basis of whether or not the sensor 702 detects that a post-processing mechanism is installed.

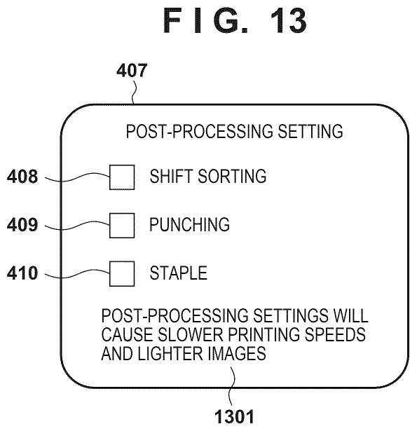

In step S103, the CPU 111 sets a post-processing mechanism installed flag held in the RAM 112. For example, in a case where the CPU 111 determines that a post-processing mechanism is installed, the CPU 111 sets an installed flag to ON. On the other hand, in a case where the CPU 111 determines that a post-processing mechanism is not installed, the installed flag is set to OFF. In a case where the installed flag is ON, the CPU 111 displays the post-processing settings button 406 on the print setting UI 401. In this manner, the user can select the post-processing settings button 406. When the user presses the post-processing settings button 406, the CPU 111 both displays the post-processing process selection UI 407 and displays a message 1301 of the action for reducing jamming as illustrated in FIG. 13. FIG. 13 is a diagram illustrating a UI for setting a post-processing process according to the second embodiment. Here, the CPU 111 displays the message 1301 of “By setting a post-processing setting, the printing speed may be reduced and the image may be lighter”. Note that the text only needs to correspond to the action for reducing jamming, and the message 1301 may be different text from this. For example, in a case where the printing speed is reduced and the printing time is increased, the CPU 111 may display a message saying “The printing time may be increased”. The following is similar to that of the first embodiment and thus will not be described.

As described above, according to the second embodiment, even if a post-processing setting is set, the user can confirm a reduction in speed, image quality, and the like. Thus, the user-friendliness can be improved by the action for reducing paper jamming.

### Third Embodiment

In the first embodiment described above, a method is used to reduce paper jamming by selecting a preset print operation mode in advance. However, the rate of jamming variates depending on a combination of factors including the image data and the printing media used by the user, printing environmental conditions such as temperature and humidity, and the like. Thus, all paper jamming cannot be reduced by a preset print operation mode. Regarding this, in a case where the highest priority print mode for avoiding paper jamming is preset, printing is always performed with the speed and the image quality reduced as much as possible.

In light of this, paper jamming can be suppressed by, when a jam occurs, incrementally prioritizing avoiding jamming by switching modes that incrementally suppress the curl amount. Hereinafter, similar configurations to that in the first embodiment will not be described, and the actual operations will be described.

### Changing Printing Operation on the Basis of Jam Occurrence Information

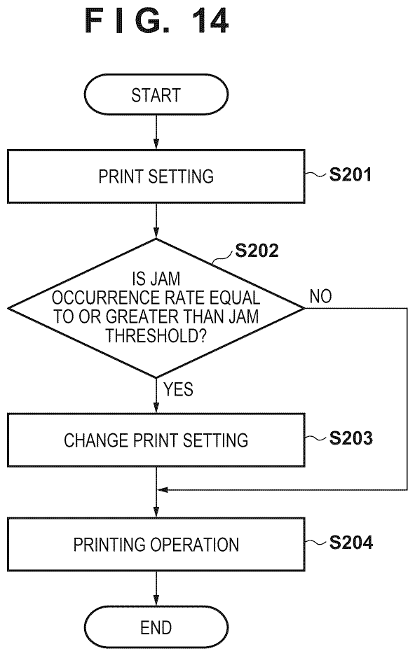

The flow of processing according to the third embodiment will be described using FIG. 14. FIG. 14 is a diagram of a flowchart illustrating the printing operation according to the third embodiment. The step for determining whether a post-processing mechanism is installed is similar to that in the first embodiment. The following flow will now be described.

First, in step S201, the CPU 111 obtains and sets a print setting set by the user via the print setting UI 401. At this time, the post-processing settings button 406 may be pressed and the post-processing setting may be performed from the post-processing process selection UI 407. In a case where a post-processing process setting is received, the CPU 111 may set a print setting for discharging paper with a reduced curl amount. Also, in a case where the set post-processing process is stapling processing for which good alignment is important, the CPU 111 may set the print setting so that paper is discharged with a further reduced curl amount compared to other post-processing processes.

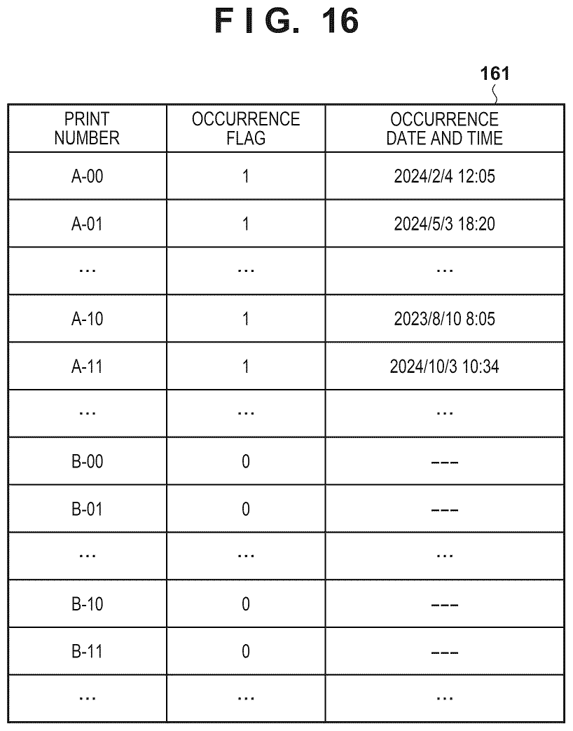

In step S202, the CPU 111 calculates the jam occurrence rate for the most recent printing and determines whether or not to change the print setting on the basis of the jam occurrence rate. Specifically, the CPU 111 determines whether or not the jam occurrence rate is equal to or greater than a jam threshold. The CPU 111 determines whether or not to change the print setting on the basis of the determination result. FIG. 16 illustrates a paper jam occurrence information table 161. The occurrence information table 161 is a table indicating information relating to paper jam occurrences. The occurrence information table 161 includes a print number and an occurrence flag and occurrence date and time associated with the print number. The occurrence flag indicates whether or not a paper jam has occurred in the printing operations of the print number. If the occurrence flag is “1”, this indicates that a paper jam has occurred. If the occurrence flag is “0”, this indicates that a paper jam has not occurred. Note that even if an occurrence flag indicates that a paper jam has occurred before, thereafter, if paper jams have not occurred in the printing operations of the same print number, the CPU 111 may set the occurrence flag to “0”. The occurrence date and time indicates the date and time of the most recent paper jam. For example, for each printing operation, the CPU 111 may update and hold the occurrence flag and occurrence date and time of the corresponding print number. In a case where the jam threshold is set to 0.5 and the occurrence information table 161 shows that in the most recent ten times printing five times or more a paper jam has occurred, the CPU 111 determines to change the print setting. The meaning of most recent here may change as appropriate and may be one hour, one day, or the like. In a case where the CPU 111 determines that the paper jam occurrence rate is not equal to or greater than the jam threshold on the basis of the occurrence information table 161, the CPU 111 proceeds to step S204 without changing the print setting. On the other hand, in a case where the CPU 111 determines that the paper jam occurrence rate is equal to or greater than the jam threshold, the CPU 111 proceeds to step S203 in order to change the print setting.

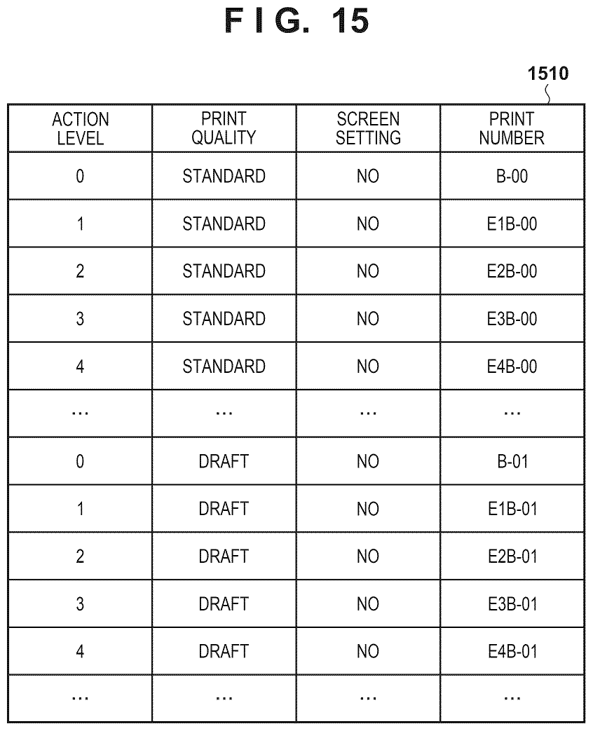

In step S203, the CPU 111 switches the printing operation table and changes to a print setting that further reduces curling. At this time, the printing operation table 1110 illustrated in FIG. 11 as well as a printing operation table 1510 for action against curling illustrated in FIG. 15 is pre-stored in the ROM 113. Thus, the CPU 111 switches the printing operation table 1110 illustrated in FIG. 11 with the printing operation table 1510 illustrated in FIG. 15. FIG. 15 is a diagram of a printing operation table for action against paper jam according to the third embodiment. The printing operation table 1510 for action against curling illustrated in FIG. 15 will now be described.

The printing operation table 1510 for action against curling illustrated in FIG. 15 includes an action level, print quality, double-sided setting, and print number. Action level indicates the level of paper jam avoidance and the level of curl amount reduction, with higher values meaning that anti-jamming action is prioritized. For example, compared to action level 1, action level 5 can further reduce the curl amount via a print setting with a smaller ink application amount, a print setting with a slower printing speed, or a combination thereof. Here, in step S202, in a case where the CPU 111 determines to change the print setting, for example, the CPU 111 changes the print setting of print number B-00 of FIG. 11 to the print setting of print number E1B-00. By making this change, the curl amount is further reduced and action to reduce paper jamming has been performed. Thus, the paper jam occurrence rate from the next printing onward can be reduced. At this time, for example, in step S202 of the next time onward, in a case where the CPU 111 determines to change the print setting, the CPU 111 can further reduce the paper jam occurrence rate by changing the print setting of print number E1B-00 to the print setting of print number E1B-01. By performing such operations, action against paper jamming can be incrementally applied. Also, in a case where the post-processing process is stapling processing for which good alignment is important, the CPU 111 may change the print setting so that paper is discharged with a further reduced curl amount compared to other post-processing processes.

Next, in step S204, when the user issues a printing instruction using the print setting of FIG. 4, the CPU 111 performs the printing operation corresponding to the print setting of the post-change print number. By operations being performed in this manner, the jam occurrence rate can be incrementally reduced for the jam occurrence rate in accordance with the printing environment of the user.

### Fourth Embodiment

In the embodiments described above, the user sets the print setting to a print setting with a reduced curl amount before a paper jam occurs. In the present embodiment described herein, the print setting is changed to a print setting for suppressing the curl amount when a paper jam occurs during a printing operation.

### Changing Printing Operation When Jam Occurs

Hereinafter, similar configurations to that in the embodiments described above will not be described, and the actual operations will be described.

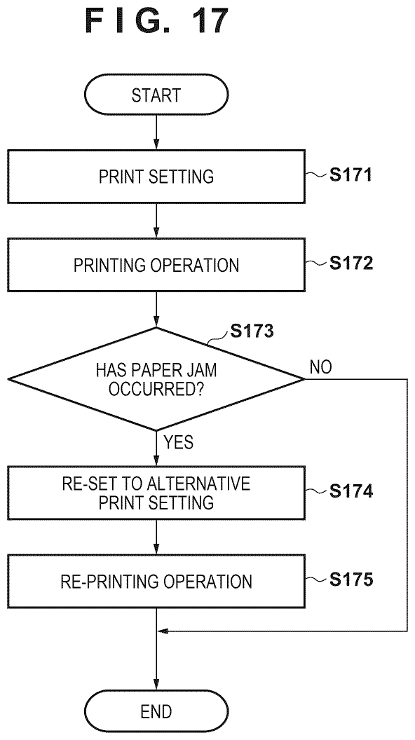

FIG. 17 is a diagram of a flowchart illustrating the printing processing according to the fourth embodiment. The printing processing according to the fourth embodiment will be described using FIG. 17. The process of installing the post-processing mechanism and the process of using a sensor to detect whether a post-processing mechanism is installed are similar to that described in the embodiments described above. The following processing will now be described.

In step S171, the CPU 111 receives a print setting from the user. For example, the CPU 111 may display the print setting UI 401 and may receive a print setting instruction from the user. Here, in a case where the user presses the post-processing settings button 406, the CPU 111 may display the post-processing process selection UI 407 and may receive the post-processing process setting from the user. In a case where a post-processing process setting is received, the CPU 111 may set a print setting for discharging paper with a reduced curl amount. Also, in a case where the set post-processing process is stapling processing for which good alignment is important, the CPU 111 may set the print setting so that paper is discharged with a further reduced curl amount compared to other post-processing processes. Note that in the present embodiment also, the printing operation table 1110 illustrated in FIG. 11 is stored in the ROM 113.

In step S172, the CPU 111, on the basis of the print setting received from the user, reads out the printing operation program and performs the printing operation so that an image is printed on a printing medium.

In step S173, the CPU 111 determines whether or not a paper jam has occurred during the printing operation. In a case where the CPU 111 determines that a paper jam has not occurred during the printing operation, the CPU 111 ends the printing processing. In a case where the CPU 111 determines that a paper jam has occurred during the printing operation, the CPU 111 proceeds to step S174.

In step S174, the CPU 111 re-sets and changes the print setting received from the user to an alternative print setting. Here, the alternative print setting is a print setting that can suppress the curl amount more than the print setting received from the user, for example. Accordingly, the CPU 111 may reference the printing operation table 1110 illustrated in FIG. 15 and may select an alternative print setting and re-set to it. For example, the CPU 111 may select and re-set, as the alternative print setting, a print setting that is the same as that received from the user except that the action level is “2”. Also, on the basis of the occurrence information table 161 illustrated in FIG. 16, the CPU 111 may select and re-set, as the alternative print setting, a print setting for which a paper jam has not occurred. Note that in a case where the CPU 111 determines a plurality of times that a paper jam has occurred, the CPU 111 may change the print setting so that the action level increases at each determination. In other words, the CPU 111 sets a new print setting so that the curl amount is incrementally reduced each time a paper jam occurs.

In step S175, the CPU 111, on the basis of the re-set new print setting, reads out the printing operation program and performs the printing operation again. Note that after the sensor or the user informs the CPU 111 that the paper jam has been resolved, the CPU 111 may resume the printing operation.

As described above, according to the present embodiment, in a case where a paper jam occurs, a print setting for suppressing the curl amount is changed to before the printing operation is restarted. This can reduce repeated occurrences of paper jamming.

### Other Embodiments

The embodiments described above may be combined. In the case of combining the embodiments, the user can select the processing of each embodiment, and the CPU 111 executes the processing on the basis of the user selection.

Note that the present embodiments described above use a serial head, but a linehead may be used. In the case of a linehead, the ink amount applied on the sheet surface at one time is great, and thus a large curl amount can be expected. In this manner, the present embodiment can be even more effective.

In the embodiments described above, the CPU 111 of the printing apparatus 108 executes the processing of the print setting and the re-setting of the print setting. However, the active agent of the processing is not limited to the CPU 111. For example, the CPU 102 of the image processing apparatus 101 may execute the processing for the print setting and the changing of the print setting. In this case, the CPU 102 displays the user interfaces on the display apparatus of the image processing apparatus 101.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-041586, filed Mar. 15, 2024, filed, which is hereby incorporated by reference herein in its entirety.

What is claimed is:

1. An information processing apparatus that controls an inkjet printing apparatus that prints an image on a printing medium and in which a post-processing mechanism that can execute a plurality of types of post-processing processes on the printing medium printed with the image can be installed at a discharge unit that discharges the printing medium, the information processing apparatus comprising:
a storage unit that stores print settings for printing the image that include at least a first print setting and a second print setting different from the first print setting; and
a control unit that sets the first print setting for executing a first post-processing process from among the post-processing processes and sets the second print setting for executing a second post-processing process different from the first post-processing process from among the post-processing processes, wherein
the control unit
sets the first print setting so that paper is discharged with a reduced curl amount more than in a case where the post-processing process is not executed, and
sets the second print setting so that paper is discharged with a curl amount reduced more than the first print setting.

2. The information processing apparatus according to claim 1, wherein the control unit receives shift sorting, stapling, or punching as a post-processing process to be executed by the post-processing mechanism.

3. The information processing apparatus according to claim 1, wherein the control unit sets the second print setting to have a lower printing duty cycle than the first print setting.

4. The information processing apparatus according to claim 3, wherein in a case where the printing duty cycle is set low, the control unit displays that a printing density of the image will be reduced.

5. The information processing apparatus according to claim 1, wherein the control unit sets the second print setting to have a longer printing time than the first print setting.

6. The information processing apparatus according to claim 5, wherein in a case where the printing time is set long, the control unit adjusts a waiting time during printing of the image.

7. The information processing apparatus according to claim 5, wherein in a case where the printing time is set long, the control unit adjusts a printing speed of the image.

8. The information processing apparatus according to claim 5, wherein in a case where the printing time is set long, the control unit displays that the printing time will be increased.

9. The information processing apparatus according to claim 1, wherein the control unit stores occurrence information indicating whether or not a printing medium jam has occurred, calculates a jam occurrence rate on a basis of the occurrence information, and determines whether or not to change a print setting on a basis of the occurrence rate.

10. The information processing apparatus according to claim 1, wherein in a case where a jam has occurred during a printing operation, the control unit changes a print setting to further reduce curling and performs a printing operation again.

11. The information processing apparatus according to claim 1, wherein the second post-processing process is a process that requires a higher alignment of printing medium than the first post-processing process.

12. An inkjet printing apparatus, comprising:
the information processing apparatus according to claim 1; and
a discharge unit that discharges the printing medium with the image printed and is installed with a post-processing mechanism that performs a post-processing process on the printing medium.

13. An information processing method for controlling an inkjet printing apparatus that prints an image on a printing medium and in which a post-processing mechanism that can execute a plurality of types of post-processing processes on the printing medium printed with the image can be installed at a discharge unit that discharges the printing medium, the method comprising:
storing print settings for printing the image that include at least a first print setting and a second print setting different from the first print setting; and
controlling to set the first print setting for executing a first post-processing process from among the post-processing processes and set the second print setting for executing a second post-processing process different from the first post-processing process from among the post-processing processes, wherein
in the controlling
the first print setting is set so that paper is discharged with a reduced curl amount more than in a case where the post-processing process is not executed, and
the second print setting is set so that paper is discharged with a curl amount reduced more than the first print setting.

14. A non-transitory computer-readable storage medium storing a computer program for causing, when loaded and executed by a computer that controls an inkjet printing apparatus that prints an image on a printing medium and in which a post-processing mechanism that can execute a plurality of types of post-processing processes on the printing medium printed with the image can be installed at a discharge unit that discharges the printing medium, the computer to:
store print settings for printing the image that include at least a first print setting and a second print setting different from the first print setting; and
set the first print setting for executing a first post-processing process from among the post-processing processes and set the second print setting for executing a second post-processing process different from the first post-processing process from among the post-processing processes, wherein
in the setting of the print setting
the first print setting is set so that paper is discharged with a reduced curl amount more than in a case where the post-processing process is not executed, and
the second print setting is set so that paper is discharged with a curl amount reduced more than the first print setting.
